(19) United States
(12) Patent Application Publication
(10) Pub. No.: US 2010/0287287 A1
(43) Pub. Date: Nov. 11, 2010

(54) Network Apparatus and Method for Translating Media Access Control Addresses

(76) Inventors: Daniele Trentini, Chiavari (IT); Paolo Massa, Genova (IT)

Correspondence Address: POTOMAC PATENT GROUP PLLC, P. O. BOX 270, FREDERICKSBURG, VA, 22404, US

(21) Appl. No.: 12/520,501

(22) PCT Filed: Dec. 21, 2006
(86) PCT No.: PCT/EP06/70114

§ 371 Date: May 12, 2010

(51) Int. Cl. G06F 15/16; H04L 29/12; H04L 12/28

(52) U.S. Cl. 709/228

(57) ABSTRACT

Network apparatus for linking a plurality of client equipments to a network service provider router, by way of Point-to-Point Protocol over Ethernet (PPPoE), the network apparatus being configured such that, in use, in sending data packets from the client equipments to the network service provider routers the Media Access Control (MAC) address of each client equipment is replaced with a MAC address of an interface card of the apparatus.

### FIELD OF INVENTION

The present invention relates to network apparatus, and in particular, although not exclusively, to access nodes which provide a link between a plurality of clients and one or more service provider routers.

### BACKGROUND

In the delivery of an IP (Internet Protocol) service Access Nodes (AN) of a Network Access Provider (NAP) or an Internet Service Provider (ISP) are used to provide a link between customers' premises Equipment CPE, such as DSL (Distance Subscriber Line) modems, and the ISP's Access Routers (AR) which link up to the Internet. The CPEs cannot connect directly to the internet but must go through the intermediary of the AN first. The AN provides a CPE with a transport channel to the AR of the CPEs choice. Once the CPE is linked to the required AR via such a channel, the customer can request the service that he requires from the ISP. In essence the AN performs two functions. The first is that of admission control, for checking on the availability of resources requested at the host-end (i.e. the CPEs). The second function is that of classification, for associating packet frames with particular communication sessions. Typically the services access protocol employed between the CPEs and the ARs is a so-called Point-to-Point Protocol (PPP). In a highly preferred embodiment we seek to provide an improved network arrangement when using PPP over Ethernet (PPPoE) protocol.

### SUMMARY OF THE INVENTION

According to a first aspect of the invention there is provided network apparatus for linking a plurality of Client Equipments (CEs) to a network service provider router (NSPR), the apparatus being configured such that, in use, in sending data from the CEs to the NSPR an identifier of each CE is replaced.

According to second aspect of the invention there is provided a method of operating network apparatus which comprises the steps of receiving data from a plurality of Customer Equipments (CE), the data from each CE including an identifier which is associated with the particular CE, and replacing each identifier before onward transmission of the data to an Access Router (AR) of a Network Service Provider (NSP).

According to a third aspect of the invention there is provided a network comprising a plurality of Client Equipments (CE), an Access Node (AN) and an Access Router (AR) which provides network access, the access node being configured such that, in use, in sending data from the CEs to the AR, an identifier of each CE is replaced.

### BRIEF DESCRIPTION OF THE DRAWINGS

One embodiment of the invention will now be described, by way of example only, with reference to the following drawings in which:

FIG. 1 is a block diagram of a network arrangement which permits access to the Internet, and

FIG. 2 is a schematic representation of the steps of the Discovery stage for a PPPoE session.

### DESCRIPTION OF AN EXEMPLARY EMBODIMENT OF THE INVENTION

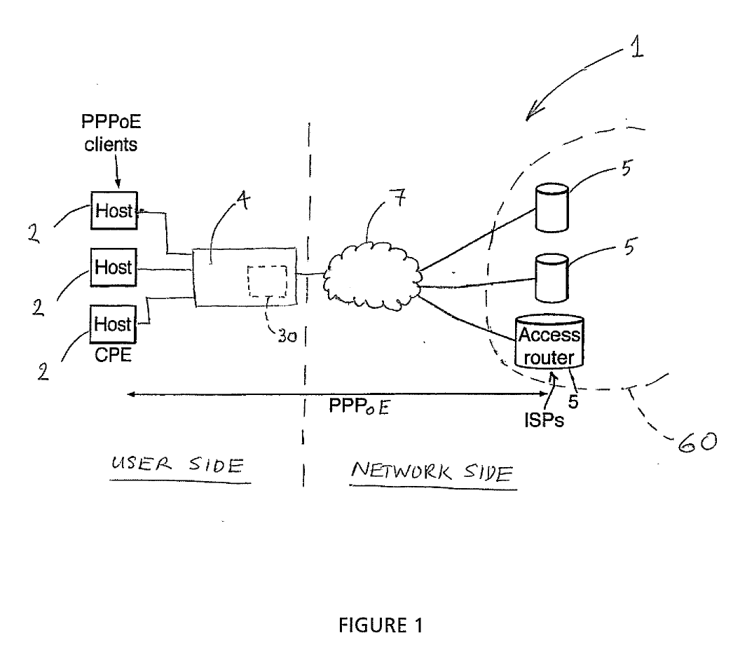

With reference to FIG. 1 there is shown a PPPoE-based network architecture 1 comprising a plurality Customer Equipments (CE) 2 (for example network terminations and/or Personal Computers), an access node (AN) 4 and a plurality of Access Routers (ARs) 5 of various Internet Service Providers (ISPs). In operation the AN 4 provides a link between the CEs 2 and the ARs 5, the ARs 5 providing access to the Internet 60. Data which passes between the AN 4 and the ARs 5 does so by way of a meshed L2 (Ethernet) network (EN) 7, the EN 7 comprising a plurality of Ethernet switches each of which comprises a forwarding database. The AN 4 is preferably a Multi-Service Access Node (MSAN) and the ARs are preferably Broadband Access Servers (BRASs). The AN 4 may be provided by the Ericsson® EDA 2500.

In the scenario considered PPPoE (Point-to-Point Protocol over Ethernet) is used on both the user side and the network side of the network arrangement 1. In particular a type of Layer Two Network Address translation “L2 NAT” is employed by the AN 4 in which one Media Access Control (MAC) address is used for each (Asymmetric Digital Subscribers Line) ADSL2 interface card in the AN. Each ADSL2 card is capable of handling a plurality of user lines. Accordingly Ethernet frames are sent to the network side with a reduced number of different source MAC addresses.

The AN 4 comprises an enclosure (not illustrated) which comprises a plurality of slots (not illustrated). Each slot is adapted to receive an interface card. Each interface card is hosted into one slot of an AN 4 shelf and provides up to sixty ADSL/ADSL2/2+ broadband user lines. It will be appreciated that the AN 4 would typically host a plurality of interface cards.

PPPoE (as defined in RFC 2516) has two distinct stages. There is a Discovery stage and a Session stage. When a Host wishes to initiate a PPPoE session, it must first perform Discovery (which may be viewed as an initialisation procedure) to identify the Ethernet MAC address of the peer and establish a PPPoE SESSION_ID.

In the Discovery process, a Host 2 (the client) discovers an Access Concentrator AC (an AR 5, which is a server). Based on the network topology, there may be more than one AC that the Host can communicate with. The Discovery stage allows the Host to discover all ACs and then select one. When Discovery completes successfully, both the Host and the selected Access Concentrator have the information they will use to build their point-to-point connection over Ethernet.

In the present embodiment different criteria are used to link PPPoE sessions on the network side (with just one Ethernet MAC address, what may be termed the “L2 NAT” MAC addresses) to PPPoE sessions on the user side (with different user Ethernet MAC addresses) per ADSL line card.

There are four steps with the Discovery stage. When these steps are complete, both peers will know the PPPoE SESSION_ID and the other peer's Ethernet address, which together define the PPPoE session uniquely.

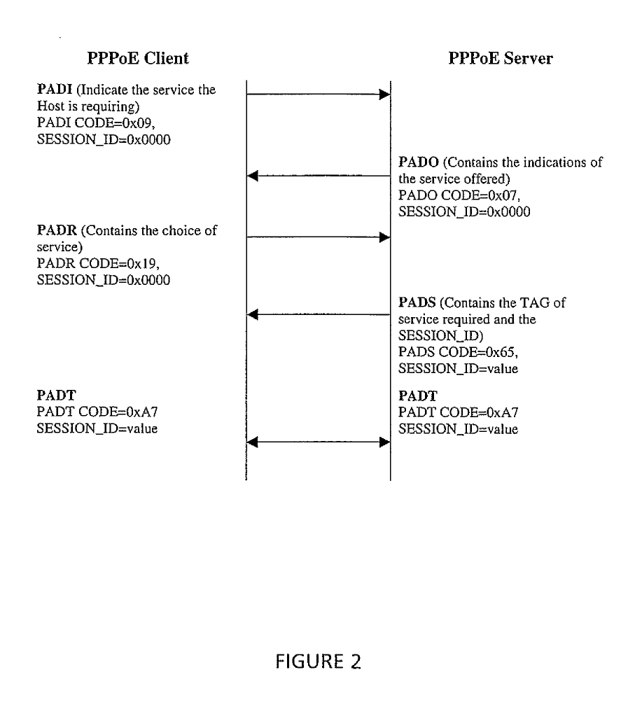

With reference to FIG. 2 the steps of the Discovery stage consist of the Host broadcasting an Initiation packet (PADI), one or more AR's 52 sending Offer packets (PADO), the CE sending a unicast Session Request packet (PADR) and the selected AR sending a Confirmation packet (PADS).

When the CE 2 receives the Confirmation packet, it may proceed to the PPPoE Session Stage (ETHER_TYPE field set to the value 0x8864).

When the AR 5 sends the Confirmation packet, it may proceed to the PPPoE Session Stage.

All Discovery Ethernet frames have the ETHER_TYPE field set to the value 0x8863.

A PPPoE Intermediate Agent 30 which is implemented in the AN 4 (and described in the DSL Forum TR-101 document “Migration to Ethernet-Based DSL Aggregation” (April 2006)) intercepts all PPPoE discovery packets (client-server direction and vice versa) on the basis of the EtherType field carried on Ethernet frame.

In the client-server direction (upstream) all PADI, PADR, and PADT packets (sent by the PPPoE client) are modified by the Intermediate Agent 30 adding a PPPoE Vendor-Specific TAG and sent to the PPPoE server on network.

The TAG contains the identification of the DSL line on which the PADI or PADR packet was received on by the AN 4 where the Intermediate Agent resides (“Agent Circuit ID”, a sub-option 1 in the format):

<Access-Node-Identifier>atm<slot>/<DSL-Line>:<VPI>.<VCI>).

In the upstream direction, during the PPPoE Discovery Stage, the “L2 NAT” must:
Gain the relationship between the “Agent Circuit ID”, that the PPPoE Intermediate Agent 30 added, and the user Ethernet MAC address
Replace on outgoing Ethernet frames the user Ethernet MAC address (the source MAC address) with the “L2 NAT” MAC address (i.e. the MAC address of the ADSL card);

In the downstream direction, during the PPPoE Discovery Stage, the “L2 NAT” must:
Remove the old relationship between the SESSION ID of the PPPoE session and the user Ethernet MAC address (if it was already present for that user)
Read the relationship between the “Agent Circuit ID”, present in Vendor-Specific TAG of PADO or PADS or PADT packets sent by the PPPoE Server, and the user Ethernet MAC address. Since the Agent circuit ID includes the respective DSL number the respective required user Ethernet MAC address can be determined
Replace the destination Ethernet MAC address incoming (the “L2 NAT” MAC address) with the associated user Ethernet MAC address.

Then the PPPoE Intermediate Agent 30 must remove the TAG before sending the packet downstream the user line to the CE 2.

When the AN 4 “L2 NAT” receives the correct PADS, the PPPoE Discovery stage has completed and it must:
Gain a new relationship between the SESSION ID of PPPoE session and the user Ethernet MAC address
Remove the old relationship between the “Agent Circuit ID”, that PPPoE Intermediate Agent 30 added, and the user Ethernet MAC address

Now the PPPoE Session stage is starting and the traffic EtherType will be 0x8864. The following behaviour is required at the AN 4 during this session:

In the UPSTREAM direction, the AN 4 must:
Replace the Ethernet MAC source address of PPPoE user frame with the “L2 NAT” MAC address

In DOWNSTREAM direction, the AN 4 “L2 NAT” must:
Read the relationship between SESSION_ID, in the received PPPoE frame, and the user Ethernet MAC address
Replace the incoming destination Ethernet MAC address (the “L2 NAT” MAC address) of the PPPoE frame with the associated user Ethernet MAC address.

It will be appreciated that additional network equipment (conventional Ethernet Switches) may be provided between the CEs 2 and the AN 4.

Advantageously the above arrangement significantly reduces the number of user MAC addresses that are presented to the network side. In the EDA2500 system, the inventive arrangement reduces the number of user MAC addresses by a factor of around sixty, due to the fact that each interface card provides 60 user lines. The arrangement is of particular benefit for network operators with L2 switches in their network which have a limited size of forwarding database. The forwarding database of each L2 switch in the network 7 is used to store the MAC addresses of Ethernet frames received. Since there would be fewer different MAC addresses to handle the memory space required is accordingly reduced.

1. Network apparatus for linking a plurality of client equipments to a network service provider router, the network apparatus being configured such that, in use, in sending data from the client equipments to the network service provider router an identifier of each client equipment is replaced.

2. Network apparatus as claimed in claim 1 which comprises a data processor interface which is adapted to received and process data from a plurality of communication lines, each communication line providing a connection between a respective client equipment and the data processor interface.

3. Network apparatus as claimed in claim 2 in which the communication lines comprise Digital Subscriber Lines.

4. Network apparatus as claimed in claim 2 which is configured to replace the identifier of a client equipment with an identifier of the data processor interface.

5. Network apparatus as claimed in claim 2 which is configured such that an identifier representative of the respective communication line associated with a particular client equipment is incorporated with data sent to the network service provider router.

6. Network apparatus as claimed in claim 2 which is configured to store an association between a client equipment identifier and the identifier of the communications line between the client equipment and the network apparatus.

7. Network apparatus as claimed in claim 2 which is operative to store an association between a session identifier and an identifier of a client equipment.

8. Network apparatus as claimed in claim 1 which is configured to replace an identifier of the network apparatus with an identifier of a client equipment.

9. Network apparatus as claimed in claim 1 in which the identifier of each client equipment comprises an Ethernet Media Access Control address.

10. Network apparatus as claimed in claim 2 in which the identifier of the data processor interface comprises an Ethernet Media Access Control address.

11. Network apparatus as claimed in claim 1 in which communication between client equipments and the network service provider routers comprises Point-to-Point Protocol over Ethernet (PPPoE).

12. A method of operating network apparatus which comprises the steps of:
receiving data from a plurality of client equipments, the data from each client equipment including an identifier which is associated with the particular client equipment; and
replacing each identifier before onward transmission of the data to an access router of a Network Service Provider.

13. A method as claimed in claim 12 in which replacement of each identifier occurs during an initial set-up procedure to establish a communication link between each client equipment and the access router.

14. A method as claimed in claim 13 in which replacement of each identifier occurs during a session procedure, and during the session procedure requests for data from the network, and data from the network, are conveyed from and to the client equipment.

15. A network comprising a plurality of client equipments, an access node and an access router, which access router provides network access, the access node being configured such that, in use, in sending data from the client equipments to the access router, an identifier of each client equipment is replaced.
